(19) United States
(12) Patent Application Publication
(10) Pub. No.: US 2010/0282839 A1
(43) Pub. Date: Nov. 11, 2010

(54) Method and system for the mobile tracking and accounting of individuals in a closed community

(75) Inventors: Christopher Zura, North Juno Beach, FL (US); Wayne Arthur Bartnick, JR., Jupiter, FL (US); Eric Hamrick, West Palm Beach, FL (US); Edward M. Sampson, West Palm Beach, FL (US)

Correspondence Address: JOSEPH R. CARVALKO, JR., 50 BEACH AVENUE, MILFORD, CT, 06460, US

(73) Assignee: SECURITY IDENTIFICATION SYSTEMS CORPORATION

(21) Appl. No.: 12/387,856

(22) Filed: May 7, 2009

(51) Int. Cl. G06K 5/00

(52) U.S. Cl. 235/382

(57) ABSTRACT

The present invention relates to a real time computer system and method as implemented on the computer system for providing interactive access control, monitoring, identifying and accounting for individuals gaining access to a closed community, comprising: registering individuals having access to the closed community, and one of mustering said individuals, tendering said individuals, verifying age of said individuals, searching said individuals, tracking said individuals for purposes of conducting a triage, responding to incidents wherein said individuals are in jeopardy, tracking excursion events of said individuals, tracking said individuals who are children and clearing enclosed spaces occupied by said individual.

### FIELD OF INVENTION

The invention relates generally to a method and system, as implemented by a software program on a computer system, for near real-time and real-time tracking and accounting of individuals to determine their absence or presence on board vessels or in stationary facilities.

### BACKGROUND

In certain settings such as schools, college dormitories, campuses, hotels, prisons, industrial complexes, power complexes, high rise office buildings, government institutions or ships it may be necessary to keep track of the location of individuals that make up a resident population for a multitude of reasons such as security, accountability or even immigration. When the public forms the resident population, administrators who have the responsibility of tracking an individual's location must do so in a non intrusive fashion. Hotels, industrial facilities, nuclear power plants and office buildings have for some time kept a strict accounting of individuals within a facility and refer to these rosters when catastrophe strikes. However, in the future for security purposes a wide variety of public accommodations may be required to better control entrance and egress through their main portals, which might support tracking whether a person within a subscribed community, such as a worker, hotel guest, student or inmate has vacated the premises.

Cruise ships have come to resemble large land resorts and they confront some of the same security issues and location tracking issues as land based resort hotels. However, in other instances cruise ships have requirements of track individuals unique to their environment. For instance, as cruise ships cross international boundaries they may face greater threats due to political issues at various ports of call. As such the cruise ships need to have a strict accounting of passengers who have left the ship. In time of emergency on board ship similarly a strict accounting of individuals is necessary. U.S. Pat. No. 6,801,907, incorporated herein by reference was granted to the inventor herewithin and, provides a thorough explanation of the threats passengers face during any sea voyage.

Ships have a particular requirement for a muster station to insure the rapid assembly of passengers and crew in cases of emergency. The muster protocols include lifeboat drills, general emergency stations support. In the U.S. compulsory coast guard muster drills are mandatory and required under U.S. law. These activities assess the readiness of a crew to execute evacuation of ships under complex of scenarios found in off shore disasters. Therefore mustering/evacuation systems and analysis must be prepared for a wide range of incidents that might occur on a ship in realistic sea environments. In a conventional muster process undertaken without the aid of a computer, the starting point is to obtain crew and passenger numbers, profiles and location, especially when status may change as for example when passengers go on shore at a tourist port.

Mustering only or mustering and embarkation/disembarkation must be efficient and safe. As ships take on greater and greater populations, crew performance and responsibilities during mustering and during a crisis generally need to be well defined and have the latest technology.

Security of closed spaces is an issue in the post-911 era. While some level of security has been accomplished in the prior art systems (see, U.S. Pat. No. 5,420,924; U.S. Pat. No. 5,864,622; U.S. Pat. No. 5,841,886; U.S. Pat. No. 5,787,186; U.S. Pat. No. 5,469,506; U.S. Pat. No. 7,076,664; JP 5 (1993)-233783 A; JP 5 (1993)-35935; JP 10 (1998)-154248), none of the prior art deals with technology to adequately assist ship crews with efficient and reliable excursion/event tracking, clear cabin assurance and child care tracking. Each of these activities deals with maintaining knowledge of the whereabouts of passengers. For example, during an off-ship excursion, the administrator of the event must be able to account for all of the individuals while at the event and account for their return. This accounting requirement is not exclusive to ships as for example a school field trip at a temporary stop where the passengers leave the transportation means. These accounts may be as simple as it might be if a tour bus were to stop at a restaurant or more complex as when passengers disembark a ship in a foreign port. Prior to disembarking a ship's crew often must engage in a lengthy and tedious cabin call process in which they attempt to manually count all those who are presently on the vessel. In the event of an emergency or catastrophe, (e.g., a ship fire or ship taking on water) there may be forced evacuation where it becomes imperative to locate all the passengers and assure that they have reached safety. Once again, in these instances a manual head count would occur, which wastes precious time and can often be incorrect due to the pressures of the situation. In other cases there may be an ongoing requirement for insuring the whereabouts of children in settings such as school or aboard ships which require accounting of the whereabouts of individuals on a near real time basis. Ships that are the size of large scale resorts need to account and be able to trace the whereabouts of designated passengers, often children, but also adults that because of infirmity or age might find themselves lost, trapped or in a state of confusion. In addition, if a patron at an event or a passenger aboard a ship receives an emergency call, the process of checking the several possible locations of the patron are incredibly inefficient and may not locate the passenger in time.

### SUMMARY OF THE INVENTION

The present invention relates to a real time method as implemented on the computer system for providing interactive access control, monitoring, identifying and accounting for individuals gaining access to a closed community, including: loading into a mobile device one memory data for registering individuals; and loading into a mobile device memory location data for one of mustering said individuals, tendering said individuals, verifying age of said individuals, searching said individuals, tracking said individuals, conducting a triage, responding to incidents wherein said individuals are in jeopardy, tracking excursion events of said individuals, and clearing enclosed spaces occupied by said individuals.

The present invention further relates to a computer system to provide an interactive access control system for monitoring, identifying and accounting for individuals gaining access to a closed community, including: a CPU, one or more databases, a plurality mobile PDA, said CPU, databases and mobile PDA operable under one or more operating systems having applications programs for creating documents for registering individuals having access, and for mustering, tendering, verifying age, searching passengers, tracking triage, responding to incidents, tracking excursion events, tracking individuals and clearing enclosed spaces.

The present invention further relates to a system that includes utilizing mobile technology for tracking excursion events include clearing immigration as well as devices for clearing closed spaces include on of class rooms, ship cabins, security cells. Additionally the system utilizes the mobile PDA to provide for photo capture of individuals and view images of the identification documents. The system further includes the use WWAN technology to forward information to a web service that distributes data to multiple backend systems including one of reservation/booking, property management, agency reporting, security and safety systems.

### BRIEF DESCRIPTION OF THE DRAWINGS

Understanding of the present invention will be facilitated by consideration of the following detailed description of the preferred embodiments of the present invention taken in conjunction with the accompanying drawings wherein:

FIG. 1a is a block diagram of a system for tracking and accounting of individuals to determine their absence or presence on board vessels in stationary facilities according to an embodiment of the present invention;

FIG. 1b is a block diagram of a system for mobile tracking and accounting of individuals according to an embodiment of the present invention;

FIG. 2 is a block diagram of a system for mobile tracking and accounting of individuals according to an embodiment of the present invention;

FIG. 3 is a block diagram of a system for mobile tracking and accounting of individuals according to an embodiment of the present invention;

FIG. 4a is a block diagram of a system for mobile tracking and accounting of individuals according to an embodiment of the present invention;

FIG. 4b is a block diagram of a system for mobile tracking and accounting of individuals according to an embodiment of the present invention;

FIG. 5 is a block diagram of a method of mobile tracking and accounting of individuals to determine their absence or presence on board vessels in stationary facilities according to an embodiment of the present invention;

FIG. 6 is a block diagram of a method of mobile tracking and accounting of individuals to determine their absence or presence on board vessels in stationary facilities according to an embodiment of the present invention;

FIG. 7 is a flow chart of a process of mobile tracking an individual in a closed environment according to an embodiment of the present invention.

### DETAILED DESCRIPTION

It is to be understood that the figures and descriptions of the present invention have been simplified to illustrate elements that are relevant for a clear understanding, while eliminating, for the purpose of clarity, many other elements found in computing systems and methods of making computations. Those of ordinary skill in the art may recognize that other elements and/or steps may be desirable in implementing the present invention. However, because such elements and process steps are well known by those of ordinary skill in the art, and because they do not facilitate a better understanding of the present invention, a discussion of such elements and steps is not provided herein.

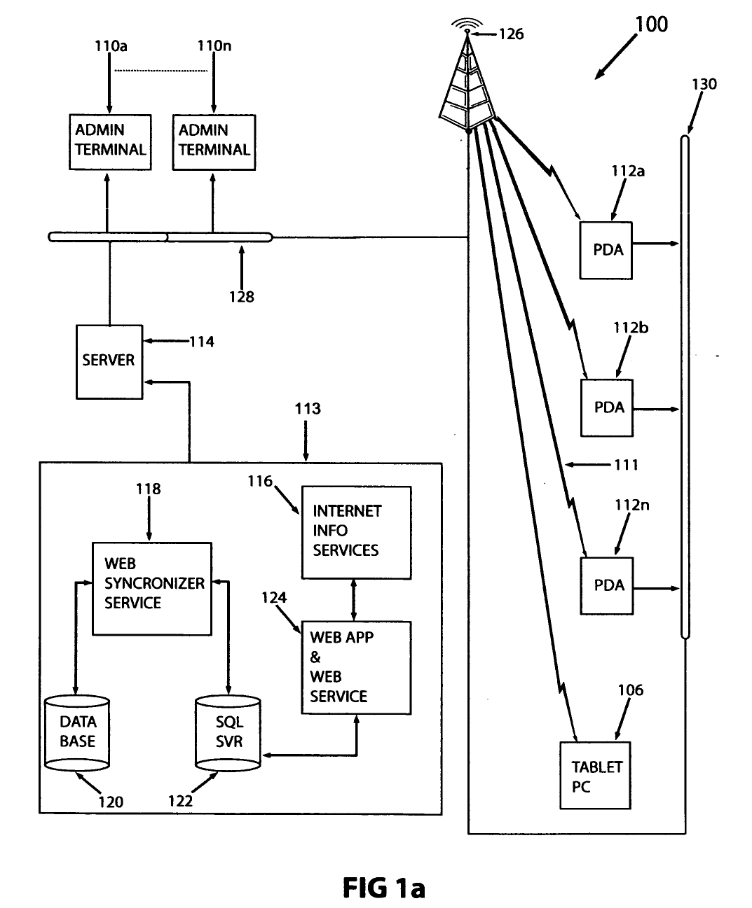

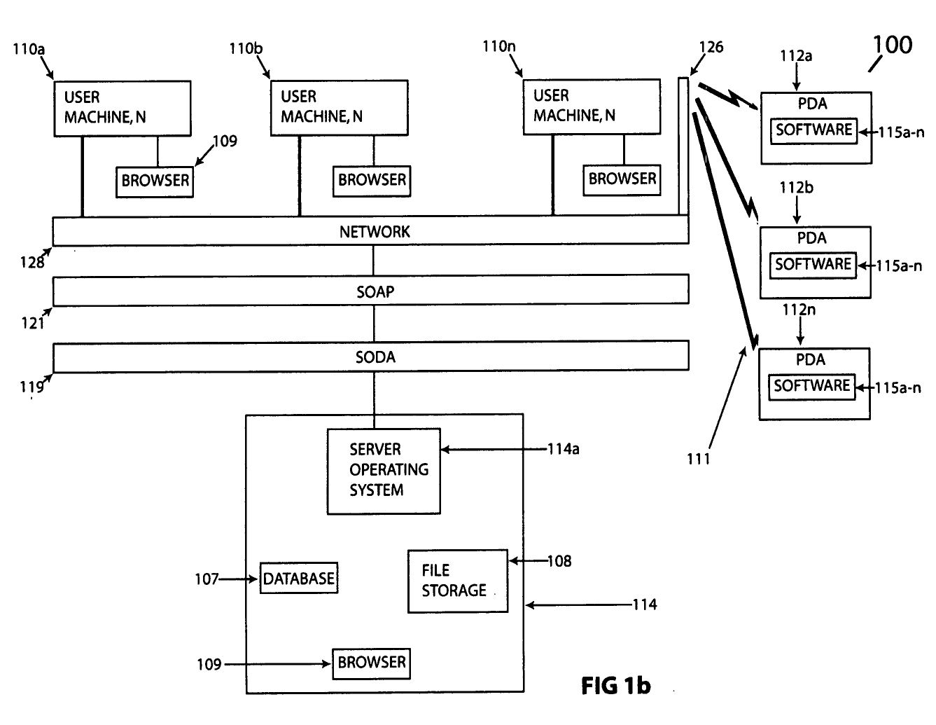

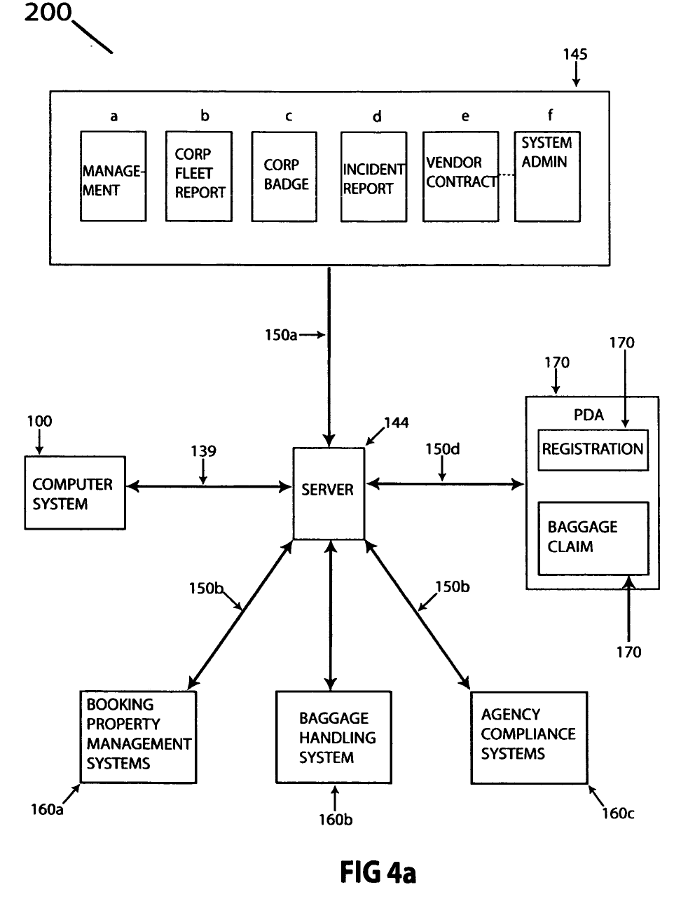

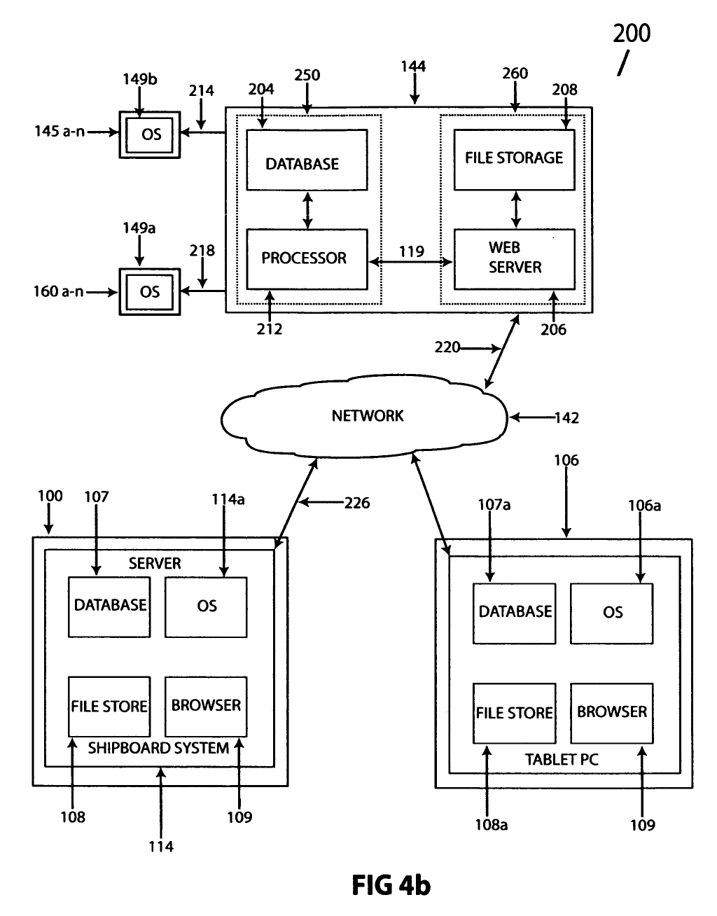

FIG. 1a of the present invention relates to a computer system 100 that provides for an interactive access control system for monitoring, identifying and accounting for individuals gaining access to a closed community, including: a server computer 114 server, one or more databases, 120, 122, a plurality of mobile PDA 112a-112n, said server computer 114, databases 120, 122 and mobile PDA 112a-112n operable under one or more operating systems having application programs for registering individuals having access, and for mustering, tendering, verifying age, searching passengers, tracking triage, responding to incidents, tracking excursion events, tracking individuals such as children and clearing enclosed spaces. A tablet PC 106 in conjunction with server computer 114 provides for a replication of the server 114 as will be more fully described in connection with FIG. 4b, below.

In the embodiment of the invention shown in FIG. 1a, system 100 has at least one platform server computer 114 to independently service multiple applications and multiple users utilizing data terminals 110a-n, various Ethernets 128, 130, a communication network 111, mobile peripheral devices 112a-112n, such as personal data assistants and server computer 114 databases 120. The computer 114 has Internet connectivity generally. Additionally computer 114 is in further in communication with subsystem 113 that incorporates an internet information services module 116 operating in conjunction with a web application and web service application 124. The web application and web service application 124 connect provides connectivity between database 122 operation under the control of an SQL server and the database 120 through web synchronizer service module 118.

Each function within subsystem 113 may be on the same computer 114 or separate computers (not shown). It is not necessary that each computer is of the same operating system, nor central processing unit (CPU) type. The computer 114, the terminals 110, the database 122 operation under the control of an SQL server and the mobile devices 112a-112n may include at least one CPU, and at least one communication port or hub, at least one random access memory (RAM), at least one read-only memory (ROM) and one or more databases or data storage devices (not shown). All of these later elements are in communication with respective CPUs to facilitate the operation of the system 100.

The computer 114 operates as a server to communicate with the terminals 110, database 122 operation under the control of an SQL server and the mobile devices 112a-112n as a distributed architecture, wherein databases and processors are housed in separate units or locations. The communications hub or port may have minimal processing capability itself, serving primarily as a communications router 126 establishing a corresponding link 111 with the computer 114. A variety of communications transports and protocols may be part of the system by way of example, but not limited to: Ethernet, Bluetooth, NMT, GSM, UMTS, HTTP, SOAP and TCP/IP or any other communication means as developed in the future. The foregoing acronyms are well know to those of ordinary skill in programming communication devices for telephone systems, wireless, satellite and Internet application. In one embodiment of the invention each of the machines 110a-n and computer 114 has an operating system such as the Microsoft Windows XP.RTM., Linux.RTM., Macintosh OSX.RTM. or any third party operating system. The operating system in each of the user machines need not be the same as long as it supports a web browser or other application to access the wide area network (WAN) or the Internet and supports the execution of codes to facilitate the intended media functions of the invention.

The mobile devices 112a-112n are used to scan a identifying artifact carried by an individual having access to the closed community for, among other uses, registration or identification using a variety of identification technologies but not limited to magnetic stripe, barcode, RFID, biometric, facial recognition or any other technology used for the purposes of rapidly scanning or processing individuals. The mobile devices 112a-112n each have software referred to as the mobile client which includes an executable software module that hosts all of the mobile application operation modes. It communicates with a web service as hosted by the server computer 114 on an application server over a secured wireless network such as networks 126, 111. A web management application program includes a work station or console 110 for full system monitoring, configuration, and administration of the mobile units along with system reporting, through the facility of a browser 109 (FIG. 1b). The web management console 110 features unit remote communication capabilities for remote control and monitoring. The system 100 allows dynamic allocation of unit resources since the operation can be reassigned from the console.

The mobile client features a full SQL mobile database supporting an offline mode complete with automatic data synchronization through a proprietary 3-way data replication scheme. Once a PDA such as represented by 112a is in range of the wireless network (or inserted into a docking station), the system provides complete data replication and collision resolution across the system, enabling accurate and up-to-date reporting regardless of interruptions in networking. This enables operations like shore side tendering with photo identification, for example, were networking resources may not always be available.

The server computer 114 system 100 also has built-in redundancy that can be configured to run on a wireless tablet PC 106 (with ad hoc networking capabilities), the entire software system 114a resident on computer system 114 is made independently portably available as a computer system 106a on tablet PC 106. Operating system 106a manages a database 107a, file storage 108a and browser 109a as well as supports a communications protocol to communicate with network 128. Tablet PC 106 essentially operates as a replicated mobile server performing the functionality of server 114. This feature is especially important when full accountability for passengers and crew is needed anytime, anywhere often under disastrous conditions.

By way of example and not limitation, the backend of the mobile client system may incorporate a Microsoft® SQL Server Express (Microsoft is a registered trademark of Microsoft, Inc., Redmond, Wash.) as the native database, however, it can support full SQL server for large data installations. The database synchronization service 118 provides a bidirectional gateway to ensure data synchronization between the database 120 and database 122 operation under the control of an SQL server. The server computer 114 can also provide connectivity to other shipboard systems through specially developed web services (not shown).

Referring to FIG. 1b, the present invention also relates to a device data linking library (DLL) interface that uses a single programming interface patterned after a service oriented device architecture (SODA) 119 layer common to all applications, where each application dynamically configures for communicating with devices assigned to a “role”, allowing the dynamic substitution of devices of the same “role” type without changing any application source code.

Referring to FIG. 1b computer 114 server operates under an operating system 114a. Operating system 114a manages a database 107, file storage 108 and browser 109 as well as supports a communications protocol to communicate with network 128. A simple object access protocol (SOAP) 121 layer represents a protocol specification for exchanging structured information between the server operating system 114a and the network 128 particularly with respect to the implementation of web services in a range of computer network applications. SOAP 121 relies on Extensible Markup Language (XML) as its message format, and usually relies on other application layer protocols (most notably Remote Procedure Call and HTTP) for message negotiation and transmission. SOAP 119 forms the foundation layer of the web services protocol stack, providing a basic messaging framework upon which web services are built.

With further reference to FIG. 1b, SOAP 119 a message sent to a web service enabled web site with the parameters needed for a search results in the site's return of an XML-formatted document with the resulting data. Because the data is returned in a standardized machine-parseable format, it is then possible to integrate directly into a third-party site. The SOAP 119 architecture consists of several layers of specifications for message format, message exchange patterns, underlying transport protocol bindings, message processing models and protocol extensibility. SOAP 119 is the successor of XML-RPC, though it borrows its transport and interaction neutrality and the envelope/header/body from elsewhere (e.g., from WDDX).

Again referring to FIG. 1b, all services as contained within the system 100 are equipment selected from the list to include server computer 114, work stations 110a-110n, PDAs or Intelligent Electronic Device (IED) 112a-112n. The work stations or user machines 110a to 110n communicate with each other and the computer 114 through the network 128. In the embodiment of the invention depicted in FIG. 1b, the work stations or user machines 110a to 110n communicate with the PDAs 112a-1112n, via telecommunication channel 111, although there may be applications where the PDAs are stored in a docking stations and the communication may optionally proceed over a wired network, such as an Ethernet 130 (FIG. 1a).

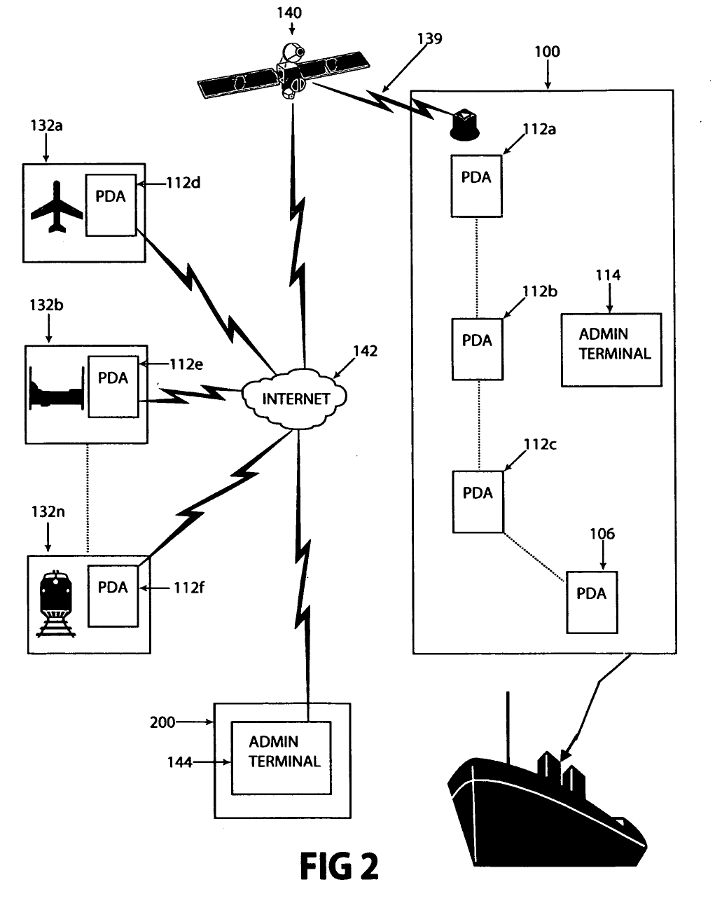

As shown in FIG. 2, the computer 114 may be configured in many different ways. For example, it may be a conventional standalone computer providing the function of server located on a ship. However the server computer 114 may also communicate or act in the capacity of a peripheral server in a larger network 200 that may include system distributed across multiple computing systems and architectures as is well known to those of ordinary skill in the art of designing computer architectures and networks. In one embodiment of the invention, a system 200 having a server 144 may be based on land at a headquarters facility. The server communicates with at least one shipboard system 100 as hereinbefore described. System 100 communicates with the server 144 via a telecommunication/satellite transmission channel 139 that in turn utilizes the internet 142 to establish communication contact with the server 144 and additionally through the internet 142 contact with other devices 132a-132n that may be employed on other modes of transportation. The network as configured in FIG. 2 permits a range of management options such as registration of passengers from remote locations such as represented by the devices 132a-132n. The communication between the shipboard system 100 and the land based system 144 permit the land based system to remain in communicative contact during emergencies, as well as during the execution of non emergency standard operating procedures such as registration of passengers, mustering, and tendering, etc.

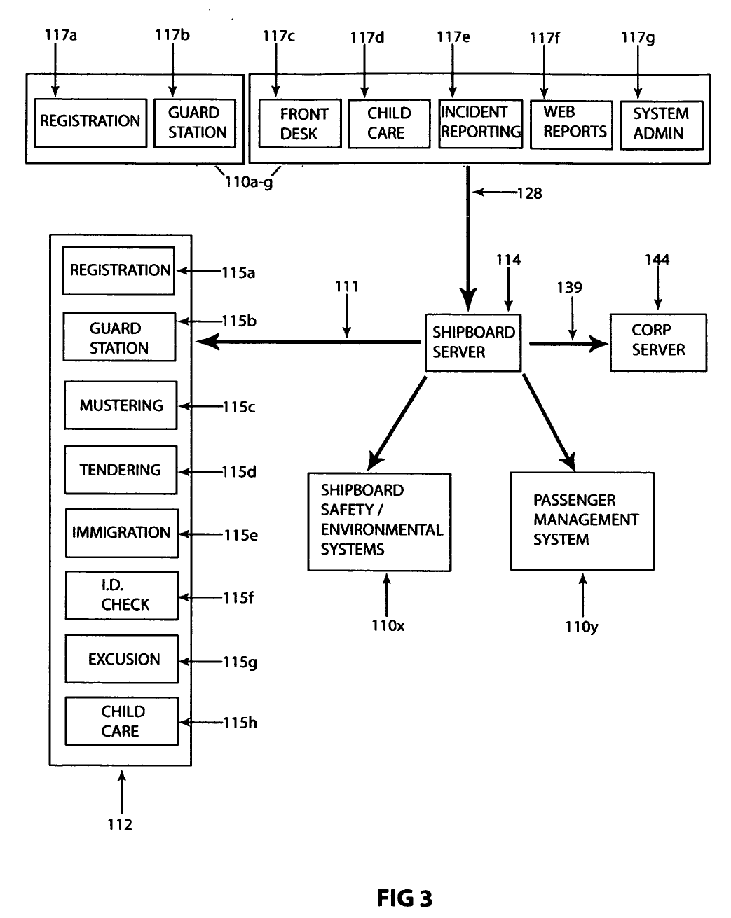

FIG. 3 of the present invention relates to the computer system 100 that provides including: the server computer 114 server, in communication with the plurality of mobile PDAs 112a-112n, and work stations 110a-110n as heretobefore described. A typical PDA 112a-112n such as PDA 112 depicted includes one or more software modules 115 for achieving the objectives of the invention such as modules for registering individuals 115a, operating as a virtual guard station 115b, mustering 115c, tendering 115d, immigration management 115e, identification check 115f, excursion 115g, and child care 115h. The PDA 112 having the forgoing software modules 115 in conjunction with the server computer 114, permits complete mustering, tendering, verifying age, searching passengers, tracking triage, responding to incidents, tracking excursion events, tracking children and clearing enclosed spaces. In addition to the mobile PDAs 112a-112n, the permanently locatable work stations 110a-110n include software modules 117 for achieving the objectives of the invention such as modules for: registering individuals 117a, operating as a virtual guard station 117b, front desk 117c, child registration 117d, incident reporting 117e, web reports 117f, and system administration 117g. The work stations 110a-110n having the forgoing software modules 117 in conjunction with the server computer 114, and the PDAs 112a-112n, such as PDA112 permits complete mustering, tendering, verifying age, searching passengers, tracking triage, responding to incidents, tracking excursion events, tracking children and clearing enclosed spaces. In one embodiment computers 110x and 110y are optional inasmuch as server 110 may incorporate the ship board safety/environmental systems and management system functions, respectively. Programming to achieve complete mustering, tendering, verifying age, searching passengers, tracking triage, responding to incidents, tracking excursion events, tracking children and clearing enclosed spaces is well known by those of ordinary skill in the art of programming databases, real time operating systems and telecommunications between various computers in a distributed mobile environment.

FIG. 4 illustrates system 200 incorporating the system 100 the latter configured to communicate with server 144 as described in FIG. 2. Server 144 communicates with one or more land based work stations 145 that provide ancillary management services for not only one such system 100, but a fleet of ships each having a system 100 prototype system on board. The computers 145 in communication with server 144 over network 150a perform functions such as management 145a, corporate fleet reporting 145b, corporate badge creation 145c, incident reporting and management 145d, vendor contract preauthorization 145e, and system administration 145f. The server 144 additionally supports over a communication channel 150d a mobile system includes PDAs 170 that as similarly described in connection with the PDAs 112a-112n, incorporates a registration module 170a, but additionally incorporate a baggage check software module 170b. Server 144 also is in communication over network 150b with a booking/property management systems computer 160a, a baggage handling system 160b and an agency compliance system 160c.

In FIG. 1a through FIG. 4, each of the computers (i.e., 114, 110a-110n, 110x, 110y, 144, 160a-160n, 170 ), PDAs 112a-112n, includes a CPU, such as one or more conventional microprocessors and one or more supplementary co-processors such as math co-processors. The processors are typically in communication with a communication port through which the processor communicates with other devices such as other servers, user terminals or devices. The communication port may include multiple communication channels for simultaneous communication with, for example, other processors, servers or client terminals. As stated, devices in communication with each other need not be continually transmitting to each other. On the contrary, such devices need only transmit to each other as necessary, may actually refrain from exchanging data most of the time, and may require several steps to be performed to establish a communication link between the devices.

The processors are also in communication with one or more data storage devices. The data storage devices may comprise an appropriate combination of magnetic, optical and/or semiconductor memory, and may include, for example, RAM, ROM, flash drive, an optical disc such as a compact disc and/or a hard disk or drive. The processors and the data storage devices each may be, for example, located entirely within a single computer, PDA, IED or other computing device; or connected to each other by a communication medium, such as a USB port, serial port cable, a coaxial cable, a Ethernet type cable, a telephone line, a radio frequency transceiver or other similar wireless or wired medium or combination of the foregoing.

The data storage devices may store, for example, (i) a program (e.g., computer program code and/or a computer program product) adapted to direct the processor in accordance with the present invention, and particularly in accordance with the processes described in detail hereinafter; (ii) a database adapted to store information that may be utilized to store information required by the program. The database includes multiple records, each record including fields specific to the present invention.

The program may be stored, for example, in a compressed, an uncompiled and/or an encrypted format, and may include computer program code. The instructions of the program may be read into a main memory of the processor from a computer-readable medium other than the data storage device, such as from a ROM or from a RAM. While execution of sequences of instructions in the program causes the processor to perform the process steps described herein, hard-wired circuitry may be used in place of, or in combination with, software instructions for implementation of the processes of the present invention. Thus, embodiments of the present invention are not limited to any specific combination of hardware and software.

Suitable computer program code may be provided for performing numerous functions such as alternative steps of invention. The computer program code required to implement the above functions (and the other functions described herein) can be developed by a person of ordinary skill in the art, and is not described in detail herein.

The term “computer-readable medium” as used herein refers to any medium that provides or participates in providing instructions to the processor of the computing device (or any other processor of a device described herein) for execution. Such a medium may take many forms, including but not limited to, non-volatile media, volatile media, and transmission media. Non-volatile media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

Various forms of computer readable media may be involved in carrying one or more sequences of one or more instructions to the processor (or any other processor of a device described herein) for execution. For example, the instructions may initially be borne on a magnetic disk of a remote computer. The remote computer can load the instructions into its dynamic memory and send the instructions over an Ethernet connection, cable line, or even telephone line using a modem. A communications device local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

Referring to FIG. 4b, the corporate system 200 server 144 may include a data storage device such as file storage 208 which includes a hard magnetic disk drive, optical storage units, CD-ROM drives, or flash memory. Data storage devices contain databases such as database 204 used in processing transactions and/or calculations in accordance with the present invention, including at least a user subscriber database and a user content database. In one embodiment, database software creates and manages these databases. System 200 related calculations and/or processing algorithms of the present invention are stored in storage device and executed by the corresponding CPU.

Computer system 250, 260 of the present invention may also interact and/or control one or more user devices or terminals (e.g., 145a-f, 160a-c, FIG. 4a). The user device or terminal may include any one or a combination of a personal computer, a mouse, a keyboard, a computer display, a touch screen, LCD, voice recognition software, or other generally represented by input/output devices required to implement the above functionality. The program also may include program elements such as an operating system, a database management system and “device drivers” that allow the processor to interface with computer peripheral devices (e.g., a video display, a keyboard, a computer mouse, etc.).

The system 200 comprises of a host 212 in synchronous communication with one or more user machines (e.g., 145a-f, 160a-c). In an embodiment, the host is a server in communication with a database 204; where the host is also in communication with a web server 206 that communicates with a file storage 208. The database 204 can be in a separate server, or can be part of the host server 212 within the same computer system 250. Similarly, the web server 206 and the file storage 208 can be separate units or can be integrated into a server 260. The physical location of the database 204, file storage 208 and the method of writing the machine executable codes being integrated into the host server 212 is not important to the invention as long as the functions are accessible to the host 212 and to the user machines (e.g., 145a-f, 160a-c).

In an embodiment, each of the user machines (e.g., 145a-f, 160a-c) has an operating system (e.g.,149a, 149b) respectively, such as the Microsoft Windows XP.RTM., Linux.RTM., Macintosh OSX.RTM. or any third party operating system. Macintosh is a registered trademark of Apple, Inc. The operating system in each of the user machines (e.g., 145a-f, 160a-c) need not be the same as long as it supports a web browser or other application to access the internet and supports the execution of codes to facilitate the intended media functions of the invention. The network 220 and the corresponding links 214, 218, 119 are part of a Wide Area Networks (WAN), Local Area Network (LAN) through Ethernet connections or wireless connections. Yet in other embodiments, the network and the links can be Local Optical Networks (LON) or direct fiber optic links or direct terminal connections or plain old telephone service (POTS). In all forms of link communications within the network 142, the communications can be enhanced with known encryption protocols to improve security.

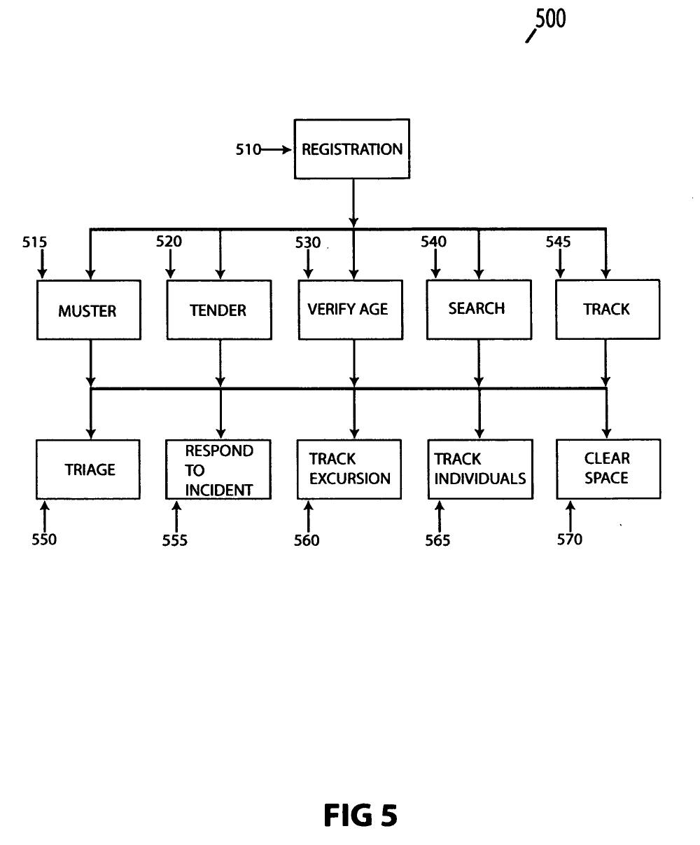

FIG. 5 illustrates an embodiment of a method 500 of the invention as implemented on a computer system for providing interactive access control, monitoring, identifying and accounting for individuals gaining access to a closed community, including: (A) utilizing mobile technology such as PDAs 112a-112n for registering 510 individuals having access to the closed community; and utilizing said mobile technology for (B) one of (1) mustering 515 said individuals, (2) tendering 520 said individuals, (3) verifying age 530 of said individuals, (4) searching 540 said individuals, (5) tracking 545 said individuals for one of (a) conducting a triage 550, (b) responding to incidents 555 wherein said individuals are in jeopardy, (c) tracking excursion events 560 of said individuals, (e) tracking said individuals 565 and (6) utilizing mobile technology such as PDAs 112a-112n for clearing enclosed spaces 570 such as by way of example and not limitation, public assembly areas, class rooms, ship cabins, security cells occupied by said individuals. Utilizing said mobile technology such as PDAs 112a-112n includes loading into the mobile device memory, data for registering individuals; and loading into a mobile device memory, data for the foregoing items 1 through 6 related to mustering, (2) tendering, (3) verifying age, (4) searching, (5) tracking and (6) clearing enclosed spaces.

The method of tracking excursion events 560 includes clearing government authorities including one of immigration, security personnel or medical officers utilizing mobile technology such as PDAs 112a-112n.

Interactive access control further includes the step of providing a single point for data collection prior to entry into controlled access. This typically exists at a pre boarding area or a controlled access where ship embarkations are taking place. Other facilities will establish other locations that serve as physical portals prior to entering the more restrictive access areas. The method of gaining access to a closed community includes the step of utilizing one or more of a PDA 112a-112-n, a digital camera, a monitor, data input means, a network interface, and a sensing mechanism operable to read an access card having machine-readable media thereon containing coded identification data. The access process typically begins by capturing and storing one of a passenger photo, government issued identification card, driver license, passport or credit card. The method utilizes WWAN technology, wherein the information is forwarded to a web service that distributes data to multiple backend systems including one of booking/registration, agency reporting, security and safety computer systems. The method 500 in conjunction with the system 100 creates an identification card with the passenger's image, referred to in this form as an access card the combination is stored in a database such as by way of example database 107 to form a unique identifier dataset. The method then permits application of the access card to various devices that read or sense the data on the card to retrieve the identification data coded thereon.

Having stored in a database such as by way of example database 107 a unique identifier dataset for each individual in the closed community, another embodiment of the invention permits comparing automatically or allowing a human operator to perform, a visual comparison of the digital image with the person bearing the access card. This in turn allows for recording one of a time of entry into an access controlled area or a time of exit from the access controlled area of a person associated with the unique identifier dataset at such time the access card is verified. The method further includes the step of storing the times of entry and exit in the database whereby a real-time accounting of personnel within the access controlled is maintained.

In one embodiment the step of mustering 515 permits a real-time status display on a designated work station 110a-n or mobile PDA devices 112a-112n. Web reporting via mobile devices PDA 112a-112n provides immediate accountability of passengers and crew. The method 500 in conjunction with the system 100 also allows for crisis management and decision for risk containment to avert catastrophes.

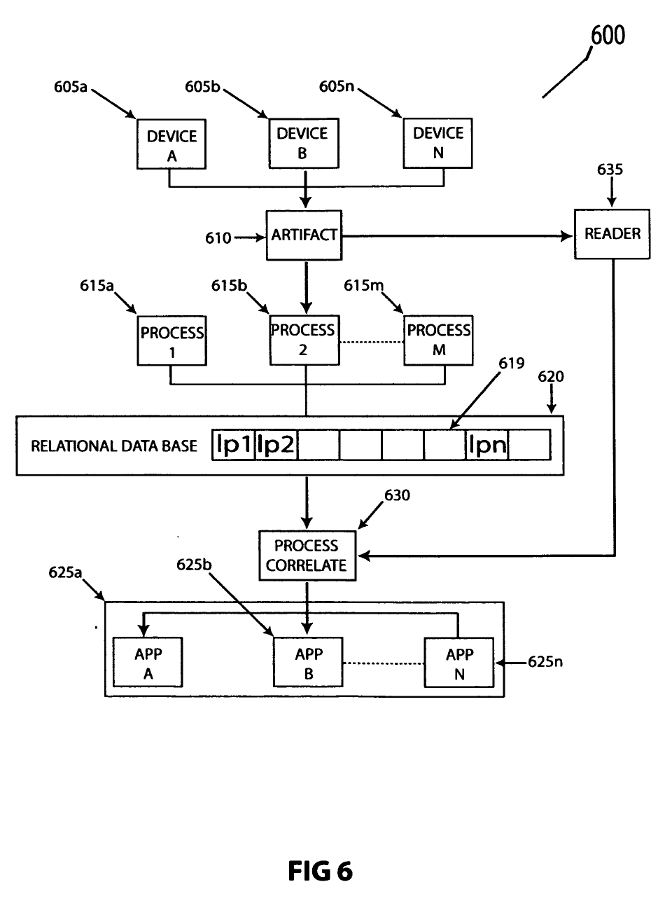

In one embodiment of the invention FIG. 6, details a method 600 utilizing a computer method to rapidly scan an identifying artifact carried by an individual having access to the closed community for, among other uses, registration or identification. As indicated any access process typically begins by capturing and storing one of a passenger photo, government issued identification card, driver license, passport or credit card. With reference to FIG. 6a, a variety of optional identification technologies 605a-n such as, but not limited to, magnetic stripe, barcode, RFID, biometric, photo for facial recognition or any other technology are used for scanning or processing individuals for later identification. The devices 6054a-n create an artifact, such as a bar code and/or a photo that is affixed to an ID card. The artifact is intended to be affixed or worn on the person of the individual to which it will later be used in an identification process. Each technology that develops the artifact creates a unique feature set to associate in a process 615a-m the artifact with an object that it identifies, storing the result into a relational database 620. Database 620 functionally may be provided by FIG. 1a, FIG. 1b databases associated with either SQL server 102 or database 107. The data from the artifact is stored in a record 619, where each element in the database record represents representational data from one of several devices that created the and associated artifact. For example, a bar code has a series of bars that signify an alphanumeric serialization that is usually associated with a database entry (a field in a data structure) to further associate an individual's name, and other identifying information is stored. A photograph creates yet another feature set that may have a data set that enables machine recognition or to recreate the photo image itself. Those of ordinary skilled in the art of engineering and programming these devices understand the technical requirements for a process 615a-m for creating databases 620 of associate information based upon input for such devices as device a-n.

In one embodiment the artifact is read by a reader device 635 which provides data identifying data for a process 630 that scans the record 619 previously created and correlates the data in the database 620 to the data read from the reader 635. The relational database 620 is then utilized by the process 630 that includes application programs 625a-n to identify individuals for the foregoing FIG. 5, items 1 through 6 related to mustering, (2) tendering, (3) verifying age, (4) searching, (5) tracking and (6) clearing enclosed spaces.

One embodiment of the invention the computer system 100 permits the definition of representative scenarios concerning time of day or night, passenger loading, incident (fire, smoke, progressive flooding, systems malfunctioning, cargo shift, foundering, combination), sea state, mustering and evacuation procedures. The computer system 100 also allows the user to make design modifications for ease of evacuation (e.g., corridors, staircases, number and location of mustering stations, and signage) aiming to optimize evacuation performance within a pre-defined set of human behavior parameters and mustering and evacuation procedures. All user communications, such as by way of example, definition of representative scenarios or modifications for ease of evacuation, between crew members can be channeled through a PDA 112a-112n, which in turn is used for evacuation announcements when required. Through the PDA 112a-112n messaging system the crew can control passengers during the evacuation process. In certain applications primary route signage can be introduced through PDA 112a-112n which in turn help crew to make passengers follow routes different from the usually assigned route or even the shortest route. Messaging through PDA 112a-112n also allows agents, particularly crew, to communicate with other ship agents, locally on ship or on the land based system designated as system 200. For example crew can react to the environment, for example in the case of blocked doors.

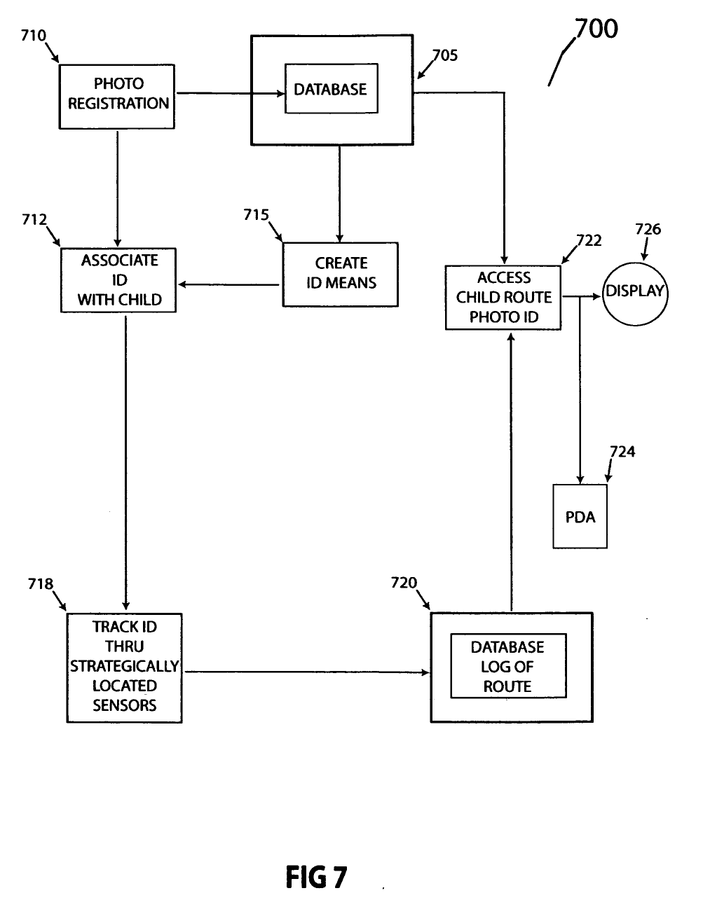

FIG. 7 illustrates one embodiment of a tracking system 700 to track an individual such as a child that is used in conjunction with the method 500 step 565 heretofore described. In one embodiment, each child undergoes a photo registration process 710 similar to that described in connection with FIG. 5, which records a digital image, in this case the child as well as information associated with and pertinent to the identification of the child 712, such as name, date of birth, names of parents or guardians, the ensemble of information of which is stored in a database, such as database 705. The photo registration process information creates an identification means 715. The means may be a RFID based tag, or other such technology that provides for near field read outs as it passes within the proximity of a reader. In at least one embodiment of the system 700, the digital photo stored in the computer is installed into a face recognition system. The digital image is compared against strategically located video and camera devices (referred to as strategically located sensors 718) that record individuals within its proximity and compares the facial features passing through the range of the camera or video against the digital images on file. Whether an automated facial recognition system, RFID or other means is employed in system 700, the strategically located sensors 718 inputs are logged into a route data base 720. The route associated with the associated identification of child 712 as read or determined by the strategically located sensors 718 are compared to the database of photo registrations 722. The route and the identification are displayed 724, 726 on corresponding displays that may by way of example associated with a PDA 112a-112n or work stations 110a-110n. In the event a child's location is required to be ascertained, the route that the child is on is immediately broadcast to one or more mobile devices PDA 112a-112n so that a crew member can take charge of the child.

Any use of the system 100 allows for recording and playback of the communication and activities managed via system 100 through the work stations 110a-110n, PDAs 112a-112n and the server computer 114 to allow the results to be reviewed at a later time. At least some of the statuses maintained by the system 100 and communicated through PDA 112a-112n are: deck occupancy; deck clearance times; fire zone evacuation times; congestion time history; fatalities; injuries; maximum density locations; status of spaces; and flooding data.

While the present invention has been described with reference to the illustrative embodiments, this description is not intended to be construed in a limiting sense. Various modifications of the illustrative embodiments, as well as other embodiments of the invention, will be apparent to those of ordinary skill in the art in reference to this description. It is therefore contemplated that the appended claims will cover any such modifications or embodiments as fall within the true scope of the invention.

What is claimed is

1. A method as implemented on a computer system for providing interactive access control, monitoring, identifying and accounting for one or more individuals gaining access to a closed community, comprising: loading into a mobile device memory data for registering one or more individuals; and loading into a mobile device memory data for one of mustering said one or more individuals, tendering said one or more individuals, verifying age of said one or more individuals, searching said one or more individuals, tracking said individuals, conducting a triage, responding to incidents wherein said individuals are in jeopardy, tracking excursion events of said individuals, and clearing enclosed spaces occupied by said individuals.

2. The method of claim 1, wherein tracking excursion events include loading into the mobile device memory data for clearing government authorities including one of immigration, security personnel or medical officers.

3. The method of claim 1, wherein closed spaces include loading into the mobile device memory data related to one of public assembly areas, class rooms, ship cabins, security cells.

4. The method of claim 1, further includes loading into the mobile device memory data related to providing a single point for data collection prior to entry into controlled access.

5. The method of claim 1, wherein entry into controlled access ship includes loading into the mobile device memory data related to embarkation.

6. The method of claim 1, further includes loading into the mobile device memory data related to capturing and storing one of a passenger photo, government issued identification card, driver license, passport or credit card.

7. The method of claim 3, further includes using WWAN technology to forward information to a web service that distributes data to multiple backend systems including one of booking/PMS, agency reporting, security and safety computer systems.

8. The method of claim 1, wherein gaining access to a closed community further includes loading into the mobile device memory data related for utilizing one or more of a PDA, a digital camera, a monitor, data input means, a network interface, and a sensing mechanism operable to read an access card having machine-readable media thereon containing coded identification data.

9. The method of claim 8, further includes loading into the mobile device memory data related to applying the access card to the sensing mechanism to retrieve the identification data coded thereon.

10. The method of claim 8, further includes loading into the mobile device memory data related to creating a digital image of a person associated with the identification data coded.

11. The method of claim 10, further includes loading into the mobile device memory data related to storing the digital image in a database in association with the identification data to form a unique identifier dataset.

12. The method of claim 9, further includes loading into the mobile device memory data related to verifying the access card by application to the sensing mechanism for interpretation of the identification data coded thereon.

13. The method of claim 11, further includes loading into the mobile device memory data related to querying the database to retrieve the unique identifier dataset.

14. The method of claim 11, further including one of loading into the mobile device memory data related to comparing automatically or allowing a human operator to perform, a visual comparison of the digital image with the person bearing the access card.

15. The method of claim 14, further includes loading into the mobile device memory data related to recording a one of a time of entry into an access controlled area or a time of exit from the access controlled area of a person associated with the unique identifier dataset at such time the access card is verified.

16. The method of claim 15, further includes loading into the mobile device memory data related to storing the times of entry and exit in the database whereby a real-time accounting of personnel within the access controlled is maintained.

17. A computer system to provide an interactive access control system for, monitoring, identifying and accounting for one or more individuals gaining access to a closed community, comprising: a CPU, one or more databases, a plurality mobile PDA, said CPU, databases and mobile PDA operable under one or more operating systems having applications programs for creating documents for registering one or more individuals having access, and for mustering, tendering, verifying age, searching passengers, tracking triage, responding to incidents, tracking excursion events, tracking one or more individuals and clearing enclosed spaces.

18. The system of claim 17, wherein tracking excursion events include clearing immigration.

19. The system of claim 17, wherein closed spaces include one of public assembly area, class rooms, ship cabins, security cells.

20. The system of claim 17, wherein PDA provides for photo capture of individuals to create an identification document.

21. The system of claim 20, wherein said access further comprises PDA viewable images of the identification document.

22. The system of claim 17, further including a means for accessing a land based server.

23. The system of claim 1 further including an independently portably available computer system that replicates the functionality of the interactive access control system for, monitoring, identifying and accounting for one or more individuals gaining access to a closed community.

24. A computer readable medium for providing interactive access control, monitoring, identifying and accounting for individuals gaining access to a closed community, comprising: code for storing data related to mobile registering of one or more individuals having access to the closed community; code for storing data related to mobile mustering said one or more individuals; code for storing data related to mobile tendering said one or more individuals; code for storing data related to mobile verifying age of said one or more individuals; code for storing data related to mobile searching said one or more individuals; code for storing data related to mobile tracking said one or more individuals for purposes of conducting a triage; code for storing data related to mobile responding to incidents wherein said one or more individuals are in jeopardy; code for storing data related to mobile tracking excursion events of said one or more individuals; code for storing data related to mobile tracking said one or more individuals; and code for storing data related to mobile clearing enclosed spaces occupied by said one or more individuals.

25. The computer readable medium of claim 24, wherein the code for storing data related to mobile mustering said individuals includes code for check-in to a muster location for one of drills or emergencies

26. The computer readable medium of claim 24, wherein the code for storing data related to mobile mustering said individuals includes code for real-time status display on a PDA.

27. The computer readable medium of claim 24, wherein the code for storing data related to mobile mustering said individuals includes code for web reporting to provide immediate mobile accountability of personnel.

28. The computer readable medium of claim 24, wherein the code for storing data related to mobile tendering said individuals includes code for the PDA to access a database with photos for emergencies.

29. The computer readable medium of claim 28 includes code for mobile tracking individuals on one or more life boats.

30. The computer readable medium of claim 24, wherein the code for storing data related to mobile tendering includes positive photo identification.

31. The computer readable medium of claim 24, wherein the code for storing data related to mobile tendering includes tracking of tender capacities.

32. The computer readable medium of claim 24, wherein the code for storing data related to tendering includes an offline mode for shore side mobile tendering operations.

33. The computer readable medium of claim 24, wherein the code for storing data related to excursion events includes mobile immigration control.

34. The computer readable medium of claim 33, wherein the code for storing data related to mobile immigration includes verification of passenger immigration clearance.

35. The computer readable medium of claim 24 wherein the code for storing data related to searching said individuals includes code for using a PDA to search by name, passport, cabin, folio, booking number, include identifying individuals in a cabin or group of individuals.

36. The computer readable medium of claim 24 wherein the code for storing data related to mobile searching said individuals.

37. The computer readable medium of claim 24 wherein the code for storing data related to mobile tracking said individuals for purposes of conducting a triage includes code for allowing medical personnel to assess, track and prioritize passenger triage areas using the international color code system.

38. The computer readable medium of claim 24 wherein the code for storing data related to mobile excursion includes code for using the PDA for check-in and attendance reporting for off-ship excursions.

39. The computer readable medium of claim 24 wherein the code for storing data related to mobile tracking individuals who are children includes child care registration.

40. The computer readable medium of claim 24 wherein the code for storing data related to mobile tracking individuals who are children includes recording an activity of a child care center.

41. The computer readable medium of claim 24 wherein the code for storing data related to mobile tracking individuals who are children includes allowing messaging to parents.

42. The computer readable medium of claim 24 wherein the code for storing data related to mobile tracking individuals who are children includes reporting information for billable service operations, such as baby sitting.

43. The computer readable medium of claim 24 wherein the code for storing data related to mobile storing data related to mobile registering individuals having access to the closed community includes code for curbside check-in.

44. The computer readable medium of claim 24 wherein the code for storing data related to mobile storing data related to registering individuals having access to the closed community includes a single point for data collection prior to actual embarkation of a ship.

45. The computer readable medium of claim 44 wherein the code for storing data related to storing data related to mobile registering individuals having access to the closed community includes a single point for data collection prior to actual embarkation of a ship includes capturing one of a passenger photo, drivers license, passport, or credit card.

46. The computer readable medium of claim 24 includes code for permitting the definition of one or more of representative scenarios concerning time of day or night, passenger loading, and one of fire, smoke, progressive flooding, systems malfunctioning, cargo shift, foundering, sea state, mobile mustering and evacuation procedures.

47. The computer readable medium of claim 24 includes code for allowing the user to make design modifications for one or more of ease of evacuation to optimize evacuation performance within a pre-defined set of human behavior parameters and mustering and evacuation procedures.

48. The computer readable medium of claim 24 includes code for which makes passengers follow routes different from the usually assigned route or even the shortest route.

49. The computer readable medium of claim 24 includes code for messaging through a PDA to allows a crew member to communicate with ship agents, locally on ship or land based.

50. The computer readable medium of claim 24 includes code for recording and playback of the communication and activities managed via a computer system.

51. The computer readable medium of claim 24 includes code for logging: deck occupancy; deck clearance times; fire zone evacuation times; congestion time history; fatalities; injuries; maximum density locations; status of spaces; and flooding data.

52. The computer readable medium of claim 24 includes code for a single programming interface patterned after a service oriented device architecture layer common to all applications.

53. The computer readable medium of claim 52 further includes code where each application dynamically configures for communicating with devices assigned to a “role”, allowing the dynamic substitution of devices of the same “role” type without changing any application source code.

54. The computer readable medium of claim 24 further including code for operating an independently portably available computer system that replicates the functionality of the interactive access control for, monitoring, identifying and accounting for one or more individuals gaining access to a closed community.
